(19) United States
(12) Patent Application Publication
(10) Pub. No.: US 2008/0055455 A1
(43) Pub. Date: Mar. 6, 2008

(54) Imbalance determination and correction in image sensing

(75) Inventor: Ilia Ovsiannikov, Studio City, CA (US)

Correspondence Address: LEFFERT JAY & POLGLAZE, P.A., P.O. BOX 581009, MINNEAPOLIS, MN, 55458-1009, US

(73) Assignee: Micron Technology, Inc.

(21) Appl. No.: 11/513,583

(22) Filed: Aug. 31, 2006

(51) Int. Cl. G02B 13/16

(52) U.S. Cl. 348/335

(57) ABSTRACT

The various embodiments described herein provide for the correction of spectral imbalance as might be caused where first pixels corresponding to a first spectral response have two or more different patterns of neighboring pixels contributing to cross-talk interference with the response of those first pixels. The differing patterns of neighboring pixels generally produce differing levels of contribution to the response of the first pixels even when subjected to the same illumination. By determining an average response of a first set of the first pixels having a first pattern of neighboring pixels and an average response of a second set of the first pixels having a second pattern of neighboring pixels, corrections for one or both of the sets of the first pixels can be determined to facilitate a mitigation of the spectral imbalance.

### TECHNICAL FIELD OF THE INVENTION

The present invention relates generally to optical devices and operation, and in particular, the present invention relates to correction of image response of image sensors.

### BACKGROUND OF THE INVENTION

Image sensors are used in many different types of electronic devices to capture an image. For example, consumer devices such as video cameras and digital cameras as well as numerous scientific applications use image sensors to capture an image. An image sensor is comprised of photosensitive elements that collect incident illumination and produce an electrical signal indicative of an intensity of that illumination. Each photosensitive element is typically referred to as a picture element or pixel.

Image sensors include charge coupled devices (CCD) and complementary metal oxide semiconductor (CMOS) sensors. Image sensors typically have color processing capabilities. The array of pixels generally employs a color filter array (CFA) to separate red, green, and blue light from a received color image. Specifically, each of the pixels is typically covered with a red, green or blue filter element according to a specific pattern. For example, the Bayer pattern has a repeating pattern of an alternating row of green and red and an alternating row of blue and green. As a result of the filtering, each pixel of the color image captured by a CMOS sensor with CFA can respond to only the illumination of wavelengths determined by the color filter of the three primary light colors.

Although the filter elements may be differently colored layers of material corresponding to the desired color response, these filter elements could also be other devices for blocking portions of a spectrum. One example is a pattern of holes of varying size in an opaque material overlying the pixels, with each hole sized to block portions of the incident light. Such pin-hole filters are typically formed during a packaging process of a semiconductor image sensor, such as by forming holes in a metal layer overlying the sensor array.

As device resolution improves, one of two choices generally need to be made: either increase the size of the sensor or decrease the size of the pixels. Manufacturers of end-use devices tend to prefer to keep the size of the sensor the same or even smaller, forcing manufactures of image sensors to decrease the size of the pixels. However, as pixel size decreases, new problems begin to arise or old problems become more prominent. One such problem is cross-talk. Cross-talk describes a general class of problems, either optical or electrical, where the response of one pixel becomes influenced by a neighboring pixel. For example, in the foregoing CFA, light passing through one filter element may fall upon a neighboring pixel, thus distorting the response of the neighboring pixel from its ideal value. As a larger percentage of the pixel becomes affected by cross-talk, the problem becomes amplified.

For example, a Bayer CFA pattern has green filters of two types, one located in rows with blue pixels and one located in rows with red pixels. In manufacturing, the same green filter is formed to create green pixels of both types in an effort to ensure that their spectral sensitivity is identical. Commonly used image processing algorithms expect that property and rely on it. Cross-talk causes responses of green pixels of the two types to differ, which degrades the quality of the processed image. The amount and spectral content of the cross-talk may vary across the sensor array and depend on the type of the scene illuminant.

For the reasons stated above, and for other reasons stated below which will become apparent to those skilled in the art upon reading and understanding the present specification, there is a need in the art for alternative image sensors and their operation.

### BRIEF DESCRIPTION OF THE DRAWINGS

FIG. 1 is a cross-sectional view of an image sensor for use with an embodiment of the invention.

FIG. 2 is a representation of a color filter array for use with embodiments of the invention.

FIG. 3 illustrates a sensor array that is subdivided into a plurality of sub-array blocks in accordance with one embodiment of the invention.

FIG. 4 is a flowchart of a method of correcting spectral imbalance in accordance with one embodiment of the invention.

FIG. 5 is a block diagram illustrating one processing pipeline for performing spectral imbalance correction in accordance with an embodiment of the invention.

FIG. 6 is a block diagram illustrating one embodiment of an imager system of the present invention.

### DETAILED DESCRIPTION OF THE INVENTION

In the following detailed description of the present embodiments, reference is made to the accompanying drawings that form a part hereof, and in which is shown by way of illustration specific embodiments in which the inventions may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

The various embodiments described herein provide for the correction of spectral imbalance as might be caused where first pixels corresponding to a first spectrum of light have two or more different patterns of neighboring pixels contributing to cross-talk interference with the response of those first pixels. The differing patterns of neighboring pixels generally produce differing levels of contribution to the response of the first pixels even when subjected to the same illumination. By determining an average response of a first set of the first pixels having a first pattern of neighboring pixels and an average response of a second set of the first pixels having a second pattern of neighboring pixels, corrections for one or both of the sets of the first pixels can be determined to facilitate a mitigation of the spectral imbalance. Although various embodiments are described with reference to visible light spectra, the embodiments are suited for use with other spectra of light.

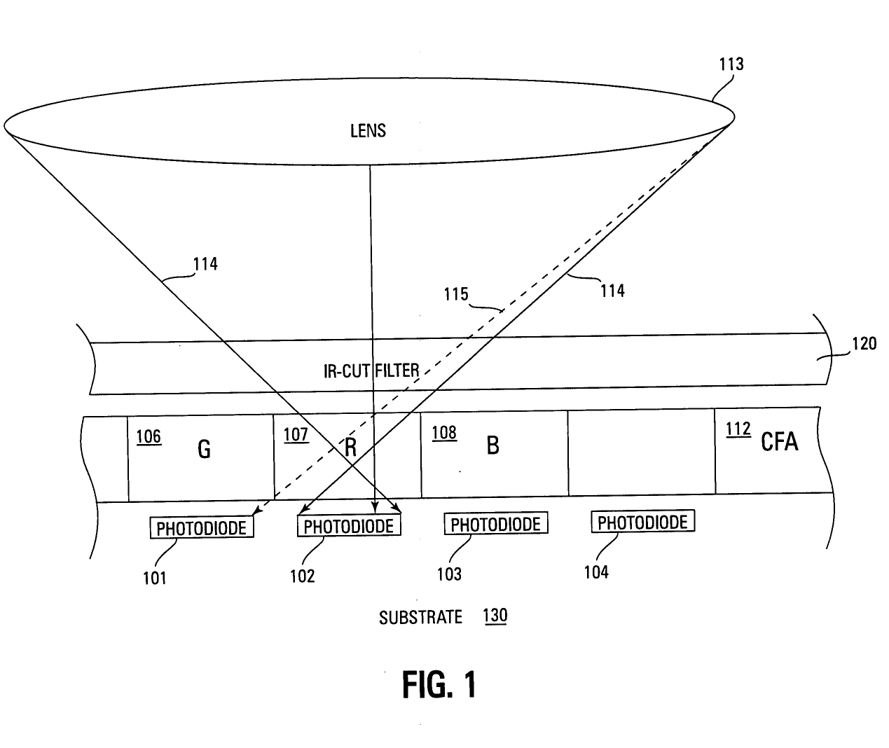

FIG. 1 illustrates a cross-sectional view of an image sensor for use with an embodiment of the invention. For purposes of clarity, not all of the layers are shown in this figure. For example, there may be metal interconnect layers formed between the layers shown as well as dielectric layers for insulation purposes.

The sensor is comprised of a substrate 130 that incorporates a plurality of pixels or photodiodes 101-104. The photodiodes 101-104 are responsible for converting light into an electrical light signal for use by the circuitry that reads the photodiode information. The higher the intensity of the light that strikes the photodiode 101-104, the greater the charge collected and the greater the magnitude of the light signal read from the photodiode.

Color filter array (CFA) 112 can be formed over the photodiodes 101-104. This optional layer comprises the filter elements corresponding to the desired color responses as required for the color system that is used. For example, the filters may be red 107, green 106, and blue 108 for an additive RGB system or cyan, yellow and magenta for a subtractive CYM system. Each filter element separates out a particular spectral response, or generally blocks passage of other spectra of light, for a corresponding photodiode.

For image devices concerned with visible light response, an IR cutoff filter 120 is often positioned over the CFA 112. This filter blocks undesirable IR light from reaching the photodiodes 101-104 to reduce its effect on the response of those photodiodes 101-104.

A lens 113 can further be positioned over the CFA 112. The lens 113 is responsible for focusing light on the photodiodes 101-104. Optionally, a plurality of micro-lenses can be formed over the photodiodes 101-104. Each micro-lens can be formed over a corresponding photodiode 101-103. Each micro-lens focuses the incoming light rays onto its respective photodiode 101-104 in order to increase the light gathering efficiency of the photodiode 101-104.

FIG. 1 demonstrates conceptually how light passing through the lens 113 may further pass through a red filter element 107 to fall on photodiode 102 as shown by lines 114. Note that FIG. 1 is not drawn to scale and that light passing through the lens 113 would generally fall upon each of the photodiodes 101-104. However, depending upon the angle of the rays of light from lens 113, some light may pass through the red filter element 107 and fall upon a neighboring photodiode rather than its corresponding photodiode 102. For example, light from the lens 113 may take the path of dashed line 115. Because the photodiodes 101-104 are generally indiscriminate as to color of light and generally respond to the intensity of that light, this added illumination coming from the red filter element 107 will distort the response of the photodiode 101 over what it should have been had it been illuminated only through its corresponding green filter element 106.

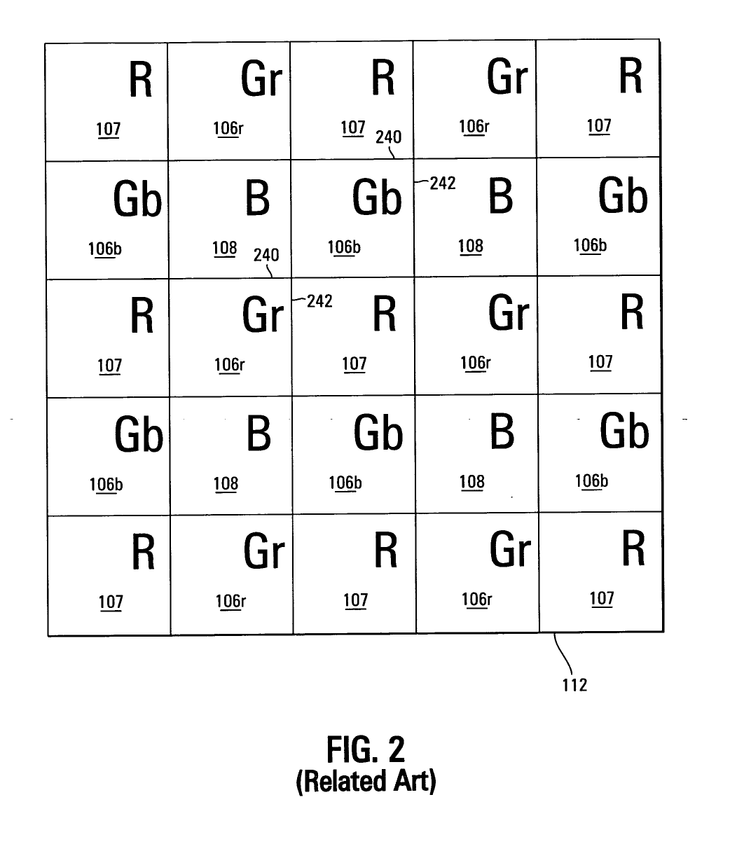

One common type of color filter array is a Bayer array. As noted above, the Bayer array is generally a repeating pattern of an alternating row of green and red and an alternating row of blue and green. FIG. 2 is a representation of a Bayer array for use with embodiments of the invention.

As shown in FIG. 2, the example Bayer array 112 includes alternating rows of red filter elements 107 and first green filter elements 106r and alternating rows of second green filter elements 106b and blue filter elements 108. Typically, there is no physical difference between the first green filter elements 106r and the second green filter elements 106b. However, in practice, the illumination of their corresponding photodiodes (not shown in FIG. 2) can differ. This difference can result from the arrangement of neighboring filter elements. For example, the first green filter elements 106r have a first side 240 bordering a blue filter element 108 and a second side 242 bordering a red filter element 107. In contrast, the second green filter elements 106b have their first side 240 bordering a red filter element 107 and their second side 242 bordering a blue filter element 108. Because corresponding sides of the green filter elements 106r and 106b have different neighboring filter elements, their response to the same pattern of light may differ due to cross-talk. For example, if the angle of stray light is such that a photodiode corresponding to a green filter element 106 receives illumination from a filter element adjacent its corresponding green filter element 106, the intensity of that stray illumination will generally differ depending upon whether it passed through a red filter element 107 or a blue filter element 108. Therefore, it is generally expected that optical cross-talk will differ depending upon the arrangement of neighboring filter elements. In other words, where such cross-talk exists, photodiodes corresponding to first green filter elements 106r would experience a different intensity of illumination than second green filter elements 106b, even if they are subjected to substantially the same illumination pattern.

For the Bayer array, the difference in response levels between photodiodes corresponding to first green filter elements 106r and photodiodes corresponding to second green filter elements 106b can be seen as a “chess board” pattern in the resulting image and may be referred to as green imbalance. The various embodiments provide methods and apparatus for correcting or mitigating this imbalance. Although the various embodiments will be described herein with reference to a Bayer filter array, embodiments of the invention are further suited for use with other filter arrays where filter elements associated with one spectral response have two or more different patterns of neighboring filter elements.

Small-geometry pixels, for example 1.75 μm square pixels, are especially prone to cross-talk effects. Lenses of imager systems equipped with sensors having such small-geometry pixels are often incapable of resolving to a single pixel of the sensor array. Moreover, scenes captured in everyday photography often contain nearly uniform areas that result in neighboring pixels in the sensor array receiving substantially the same illuminance. Due to these two factors it is often expected that a photodiode corresponding to a single filter element will see substantially the same intensity of illumination as its closest neighboring photodiodes. Thus on average, the first green filter elements 106r of a first row 244 of the filter array 112 are expected to see substantially the same intensity of illumination as the second green filter elements 106b of a second row 246 of the filter array 112. Consequently, if on average, the responses of pixels of the first type differ from the responses of pixels of the second type, the difference can be attributed to cross-talk, the amount of cross-talk on average can be assessed, and that cross-talk can be compensated for on average.

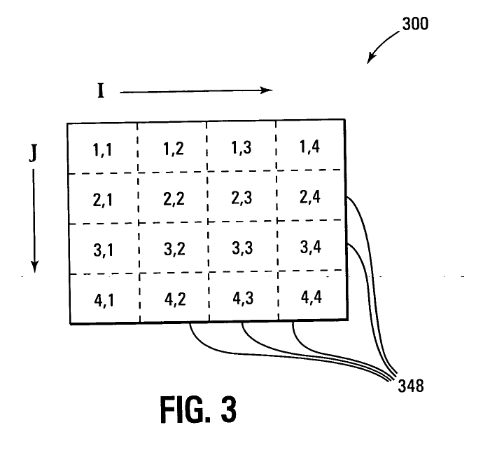

Cross-talk typically varies as a function of pixel location in the sensor array. For example, rays converging on pixels located on the sensor periphery typically may have an oblique angle of incidence and thus cause elevated amounts of cross-talk. Therefore, various amounts of cross-talk compensation should be applied to various locations in the sensor array. To assess the cross-talk at different locations in the sensor array we can subdivide the sensor array into a set of sub-windows, or sub-array blocks. FIG. 3 illustrates a sensor array 300 that is subdivided into a plurality of sub-array blocks 348 in accordance with one embodiment of the invention. The embodiment illustrated in FIG. 3 uses a grid size of 4×4 sub-array blocks 348. Each sub-array block 348 is uniquely identified and labeled with its I,J coordinates that are used by any system controller responsible for determining and storing the status of each sub-array block 348 as described in the following embodiments.

There is no certain quantity of pixels (i.e., photodiodes) assigned to each sub-array block 348. The grid size of the sensor array of FIG. 3 is for purposes of illustration only. Alternate embodiments may use other quantities, sizes or shapes of sub-array blocks in order to accomplish the imbalance correction embodiments disclosed herein. For example, the sub-array blocks may encompass entire rows of the sensor array rather than a sub-array block containing only a portion of a row of the sensor array as depicted in FIG. 3, i.e., the sub-array blocks 1,1 through 1,4 could represent one sub-array block. Furthermore, there is no requirement that the sub-array blocks be arranged in a regular array or be of the same size. For example, the sensor array could utilize smaller sub-array blocks toward the center of the array where a subject is most likely to appear and larger array blocks toward the periphery. Also, for one embodiment, the sensor array is not subdivided such that the determination of imbalance would be performed on the sensor array as a whole.

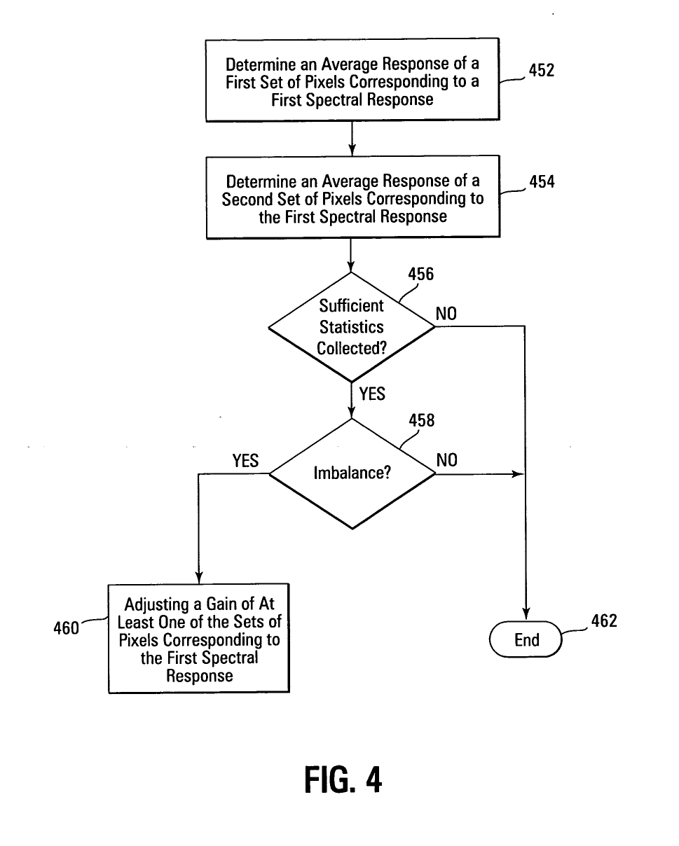

FIG. 4 is a flowchart of a method of correcting spectral imbalance in accordance with one embodiment of the invention. For a first set of pixels corresponding to a first spectral response, an average response is determined at block 452. The pixels corresponding to a first spectral response may be, for example, the pixels corresponding to the green filter elements 106r and 106b. The first set of such pixels may be all of the pixels of the sensor array corresponding to the first green filter elements 106r or all of the pixels of a portion of the sensor array, such as a sub-block 348, that correspond to the first green filter elements 106r.

For one embodiment, the average response determined in block 452 may be an average of each of the pixels of the first set. However, it may be desirable to only consider those pixel responses that are above some threshold value Tₘᵢₙ, i.e., ignoring pixels that are dark. The number of pixels from the first set having a value exceeding threshold Tₘᵢₙ are counted and designated as N₁. As one example, a pixel may have a potential response in the range of 0 to 1,023 for a 10-bit image. If a threshold value is set at 255, only those pixel responses of 256 and higher would be used in determining the average response, thus ignoring those pixels in the lower quarter of the dynamic range. In addition, the average response may be determined using the raw sensor data, either before or after lens vignetting corrections. Lens vignetting corrections account for expected intensity fall-off at the edges of a sensor array inherent in the lens system focusing the light onto the sensor array. For one embodiment, the average responses are determined using raw data from the sensor and before lens vignetting correction. For a further embodiment, this raw data should be corrected for black level, i.e., zero pixel value should correspond to zero illumination incident on a pixel.

For a second set of pixels corresponding to the first spectral response, an average response is determined at block 454. The second set of pixels may be all of the pixels corresponding to the second green filter elements 106b for substantially the same portion of the sensor array used to define the first set of pixels. However, the first set of pixels may or may not include the same number of rows of pixels as the second set of pixels. The guidance for determining the average response in block 454 is generally the same as provided with respect to block 452. The number of pixels from the second set having a value exceeding threshold Tₘᵢₙ are counted and designated as N₂.

The method may optionally determine at block 456 whether the statistics gathered in blocks 452 and 454 are sufficient. For example, threshold values may be set on the number of pixels necessary to perform the calculations in order to help ensure that the result is statistically significant. This can be achieved by comparing N₁ and N₂ to some minimum number Nₘᵢₙ:

N₁>Nₘᵢₙ and N₂>Nₘᵢₙ Eq. (1)

Nₘᵢₙ can be expressed as a percent of pixels in a sub-array block. For example, Nₘᵢₙ can be set to 5% of the number of pixels in a sub-array block. In general, Nₘᵢₙ should be sufficiently high to help ensure that the calculated averages are substantially noise-free, thus facilitating a stable operation of the algorithms. Having Nₘᵢₙ too high, however, may lead to Eq. (1) being false while imaging typical scenes using typical exposure settings, thus preventing the algorithm from performing the response balancing.

Threshold value Tₘᵢₙ is chosen, for example, to be low enough to fulfill Eq. (1) while being substantially high to help ensure a low noise level in pixel values. A higher value of Tₘᵢₙ is also desirable to prevent local colored, highly chromatic image areas producing low pixel values in pixels corresponding to the first spectral response from excessively skewing the collected average values. Such effect could result in unusually high imbalance estimates that, after applying imbalance compensation, overcompensate other non-colored areas in the sub-array block.

Based on the determined average responses of the first and second sets of pixels, it is determined at block 458 whether there is an imbalance between the two sets of pixels. For one embodiment, an imbalance will be deemed to exist if the ratio of the average response of the first set to the average response of the second set is not equal to 1. However, it may be desirable to forego correction if the ratio is sufficiently near to 1. This would save computation time if the correction might be of little consequence, or even imperceptible, to an end user. For example, an imbalance may only be deemed to exist if this ratio is less than 0.98 or greater than 1.02. Other error thresholds may be chosen as the determination as to what would be acceptable to an end user is subjective.

It is noted that some image devices may apply analog gains to the sensed data values of the various pixel types. If the image device is applying differing analog gains to the pixels of the first and second sets, the determination of an imbalance should take these gains into account. For example, consider that the average response of the first set of pixels is M_{gr} and the average response of the second set of pixels is M_{gb}, and analog gains of A_{gr} and A_{gb} were applied to the first and second sets of pixels, respectively, prior to calculating the average responses. In this case, the estimated imbalance, I, is M_{gr}/M_{gb}. Even if the average response of the raw data were identical, the estimated imbalance I would be the ratio of the gains, i.e., A_{gr}/A_{gb}, and might be indicative of an imbalance where none exists. To correct for this situation, the estimated imbalance I could be multiplied by the inverse ratio of the gains, i.e., the ratio of the gain for the second set of pixels to the gain of the first set of pixels or A_{gb}/A_{gr}, before making the determination as to whether an imbalance exists.

If no imbalance is deemed to exist, the method ends at block 462 to resume other processing of the image data. If an imbalance is deemed to exist, the method proceeds to block 460 where an adjustment may be made to the data for at least one of the sets of pixels in order to bring the ratio of the average responses closer to one. For one embodiment, a gain is applied to the data corresponding to the set of pixels having the lowest average response. For example, if M_{gr}>M_{gb}, a gain, K_{gb}=M_{gr}/M_{gb}, could be applied to the image data of the pixels having the lower average response M_{gb} such that its adjusted average response would equal the average response of the first set of pixels. Alternatively, a gain, K_{gr}=M_{gb}/M_{gr}, could be applied to the image data of the first set of pixels. Both sets of image data could also be adjusted toward each other, e.g., applying a first gain, K_{gr}=0.5*(M_{gr}+M_{gb})/M_{gr}, to the image data of the first set of pixels and a second gain, K_{gb}=0.5*(M_{gb}+M_{gr})/M_{gb}, to the image data of the second set of pixels, where K_{gr}/K_{gb} is substantially equal to M_{gb}/M_{gr}. In such alternative scenarios, the dynamic range of the pixels having the higher average response will be reduced as a gain of less than 1 is applied. However, adjusting both gains may help prevent the appearance of a color cast in the resulting image. Application of a gain less than 1 can result in some pixel values never reaching a maximum possible value, e.g. 1023 for a 10-bit image. In such case, the image processing pipeline could apply an additional, equal, gain to all color channels to make that gain reach a value of 1.

As noted previously, it is generally true that the resolution of the sensor array would be sufficiently high that the lens of the imager system would be incapable of resolving an image to a single pixel. This blurring of the image across multiple pixel planes should be sufficient to facilitate the imbalance estimation detailed above. Blurring of the image can also occur due to movement of the imager system, such as camera shake or moving of the camera to aim at a target. Because blurring will tend to remove high-frequency components from the image, the imbalance estimation may improve if calculated during movement of the imager system. Thus, if motion detection is available in the imager system, the estimation may be performed in response, at least in part, to detected motion. Similarly, suppression of high-frequency components can be improved by increasing frame integration time, i.e., the period of data collection, and decreasing any applied analog gain. Furthermore, if the imager system is equipped with an auto-focus system, such as an auto-focusing lens system, a temporary de-focus of the lens could be forced, and the collection of data for the imbalance estimation could be performed while the image is blurred.

To mitigate against gross errors, limits could be applied to the imbalance correction. This could limit correction when imaging highly-chromatic objects or objects exhibiting fine patterns that may introduce aliasing into the pixel responses. Such objects may yield erroneously high values of cross-talk estimates. If fully compensated, areas surrounding such objects may become over-corrected, thus degrading image quality. For example, a lower threshold and an upper threshold could be set such that no correction is made if the estimated imbalance I is below the lower threshold or above the upper threshold. For example, the lower threshold may be set at 0.9 and the upper threshold may be set at 1.1.

Furthermore, imbalance will generally differ as a function of pixel location. While the use of subdivision of the sensor array will improve the accuracy of the corrections, applying a single correction to each zone may still create artifacts at zone boundaries. Therefore, improvements can be obtained by adjusting the correction factor based not only upon the imbalance of the sub-array block, but upon the position of the pixel relative to the center of the sensor array or neighboring sub-array blocks. For example, the correction of a pixel response near the center of a sub-array block may be substantially equal to the correction calculated for its sub-array block, while the correction of a pixel response near a center of an edge of a sub-array block may be approximately equal to an average of the correction calculated for its sub-array block and the correction calculated for the adjacent sub-array block. In this manner, pixels located at sub-array block boundaries would receive substantially the same correction as their neighboring pixels. Adjusting corrections based both upon zones and location relative to a center point is a concept that is typical in lens vignetting corrections used to adjust for intensity fall-off of a lens system. U.S. Patent Application Publication 2006/0033005 A1 to Jerdev et al. and published Feb. 16, 2006 provides an example of one such lens vignetting correction method demonstrating how positional gain adjustments can be made. In practice, lens vignetting corrections apply varying gains to pixel responses in order to compensate for an expected loss of intensity for pixels located farther from the center of the lens system. The corrections are performed using profiles associated with various areas of the sensor array indicative of how much gain should be applied to their associated areas. Advantageously, these lens vignetting profiles could be modified in response to the imbalance estimate determined for the corresponding area of the sensor array, thus avoiding a need for a separate algorithm for applying imbalance corrections.

For embodiments where lens vignetting corrections are either not performed or are outside the capabilities of the imager system, the corrections can be applied uniformly across the area under calculation, or the corrections could be weighted or interpolated to reduce variations of the corrections at block boundaries.

For embodiments where lens vignetting corrections are performed by the imager system, the resulting lens vignetting profile may be dynamically adjusted to approximately make the ratio of correction gains, e.g., K_{gr}/K_{gb}, approximately equal to the estimated imbalance I at each pixel location. To facilitate while balance across the image, both gains may be adjusted, with excessive gains being lowered and lower gains being increased.

The adjustment of the correction gains can be done in a smooth, continuous fashion or in a one-shot calculation. For continuous adjustment, such as for preview of an image by the imager system, the correction gains may be updated iteratively on each frame as follows:
1) Estimate imbalance I for each sub-array block;
2) Adjust estimate I to account for changes in sensor analog gains,

$${I}_{adj} = I * \frac{{A}_{gb\_new} / {A}_{gb}}{{A}_{gr\_new} / {A}_{g r}} \qquad Eq . ( 2 )$$

where A_{gb}_{_{—}}_{new} and A_{gr}_{_{—}}_{new} are the analog gains to be applied for the next image frame;
3) Adjust current working estimate K for each set of pixels under consideration if sufficient statistics are available for that sub-array—Use time filtering to avoid oscillations and abrupt jumps, e.g.,

K_{i+1,j}=I_{adj}*α+K_{i,j}*(1−α) Eq. (3)
where “α” is a filter exponential decay coefficient controlling reaction speed of the filter with 0<α<=1, “i” is the frame number and “j” designates planes or rows of the differing pixels corresponding to the same spectral response;
4) Interpolate between regions and generate settings for lens vignetting correction; and
5) Put Kᵢ₊₁ in effect by programming these coefficients into lens vignetting correction.

The actual imbalance in capture of an image may differ from the estimated imbalance from the image preview. However, the correction of the captured image could be performed using the estimated imbalance I determined during preview as an approximation of the actual imbalance. Alternatively, the imbalance I may be calculated based on data of the capture of the full resolution frame and the collected data corrected in response. This is equivalent to having α=1 in preview.

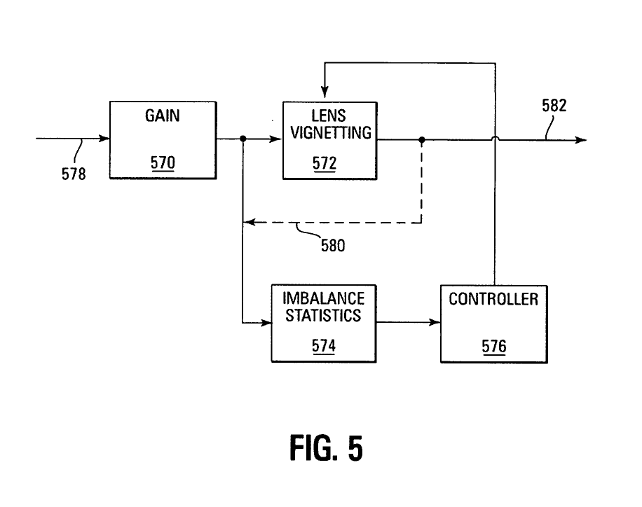

FIG. 5 is a block diagram illustrating one processing pipeline for performing imbalance correction in accordance with an embodiment of the invention. Image data, such as raw RGB data from an analog-to-digital converter (ADC) of an image sensor is received at 578. A system gain may optionally be applied to the image data at gain module 570. The image data is then supplied to imbalance statistics module 574 for estimating imbalance based on the image data. Alternatively, further adjustment of the image data may be performed at lens vignetting module 572 prior to providing the image data to the imbalance statistics module 574, as shown by dashed line 580. For each area of the image, i.e., each sub-array block of the sensor array, the imbalance statistics module 574 may calculate an average response for a first and second set of pixels corresponding to a first color response, and a count of pixels used in calculating the average responses. The controller module 576 then estimates imbalance based on the statistics from the imbalance statistics module 574, generates an updated lens vignetting profile, and provides the updated lens vignetting profile to lens vignetting module 572. The lens vignetting module 572 then performs positional gain adjustment based on the updated lens vignetting profile, and outputs the updated image data for any downstream processing, such as compression or interpolation. Although the modules of FIG. 5 could be implemented as a hardware solution, software implementation would generally follow the same processing as described above.

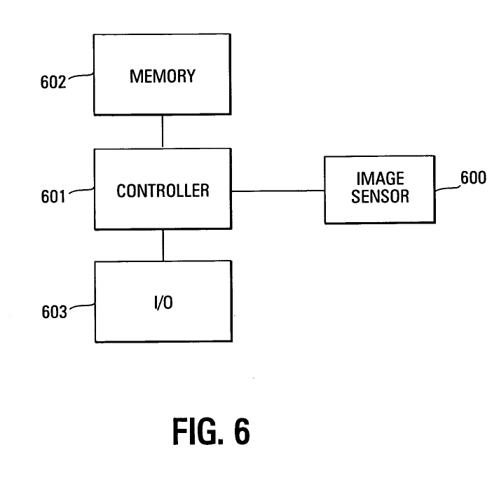

FIG. 6 is a block diagram illustrating one embodiment of an imager system of the present invention. The system comprises an image sensor 600 as described previously, coupled to a control circuit 601. This system can represent a still camera, video camera, camera phone or some other imager device.

In one embodiment, the control circuit 601 is a processor, microprocessor, or other controller circuitry that reads and processes the image from the image sensor 600. For example, the imager system can be a digital camera in which the image sensor 600 is exposed to an image for recording. The control circuitry 601 executes the above-described embodiments and reads the accumulated charges from the photodiodes of the image sensor 600. The control circuitry 601 can then process the image using the above-described methods and apply corrections to the image data. The corrected image data can be stored in memory 602. The memory 602 can include volatile memory such as RAM and/or non-volatile memory such as flash memory and can be fixed or removable. The memory 602 can also include non-semiconductor type memory such as disk drives.

The data from the system can be output to other systems over an I/O circuit 603. The I/O circuit 603 may be a Universal Serial Bus (USB) or some other type of bus that can connect the imager system to a computer, a mass storage device or other system. The I/O circuit 603 may further include a display or graphical user interface for displaying images generated by the imager system or for displaying control options to a user of the system.

### CONCLUSION

Methods and apparatus have been described to determining and correcting for spectral imbalance as might be caused where first pixels corresponding to a first color response have two or more different patterns of neighboring pixels contributing to cross-talk interference with the response of those first pixels. The differing patterns of neighboring pixels generally produce differing levels of contribution to the response of the first pixels even when subjected to the same illumination. By determining an average response of a first set of the first pixels having a first pattern of neighboring pixels and an average response of a second set of the first pixels having a second pattern of neighboring pixels, corrections for one or both of the sets of the first pixels can be determined to facilitate a mitigation of the spectral imbalance.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention.

What is claimed is:

1. A method of determining an imbalance in image sensing, comprising:
collecting image data from an array of photosensitive elements;
determining an average value of the image data for a first set of the photosensitive elements, wherein the first set of the photosensitive elements are configured to collect image data indicative of a luminance intensity of a first spectrum of light;
determining an average value of the image data for a second set of the photosensitive elements, wherein the second set of the photosensitive elements are configured to collect image data indicative of a luminance intensity of the first spectrum of light and wherein the first and second sets of the photosensitive elements are mutually exclusive; and
comparing the average value of the image data for the first set of the photosensitive elements to the average value of the image data for the second set of the photosensitive elements.

2. The method of claim 1, wherein the first spectrum of light corresponds to one color response of the array of photosensitive elements.

3. The method of claim 1, further comprising:
wherein the first set of the photosensitive elements has a first pattern of neighboring photosensitive elements configured to collect image data indicative of luminance intensity of other spectra of light;
wherein the second set of the photosensitive elements has a second pattern of neighboring photosensitive elements configured to collect image data indicative of luminance intensity of the other spectra of light; and
wherein the first pattern is different than the second pattern.

4. The method of claim 1, wherein determining an average value of the image data for a set of the photosensitive elements further comprises determining the average value of the image data for that set of the photosensitive elements using only the image data corresponding to photosensitive elements of that set having a data value greater than a threshold value that exceeds a data value for a minimum response of a dynamic range of the photosensitive elements.

5. The method of claim 4, wherein the threshold value is indicative of a response of at least about 25% of the dynamic range of the photosensitive elements.

6. The method of claim 1, wherein comparing the average values comprises determining a ratio of one average value to the other and wherein the ratio is indicative of a degree of imbalance.

7. The method of claim 6, further comprising:
correcting for the imbalance if the ratio of one average value to the other is outside a first predetermined range of values.

8. The method of claim 7, wherein the first predetermined range of values for the ratio is approximately 0.90 to 1.10.

9. The method of claim 7, further comprising:
not correcting for the imbalance if the ratio of one average value to the other is inside a second predetermined range of values.

10. The method of claim 9, wherein the second predetermined range of values of the ratio is approximately 0.98 to 1.02.

11. The method of claim 1, further comprising:
determining an average value of the image data for a third set of the photosensitive elements, wherein the third set of the photosensitive elements are configured to collect image data indicative of a luminance intensity of the first spectrum of light and wherein the first, second and third sets of the photosensitive elements are mutually exclusive; and
comparing the average value of the image data for the first set of the photosensitive elements to the average value of the image data for the third set of the photosensitive elements.

12. A method of correcting a color imbalance in image sensing, comprising:
collecting image data indicative of a response of an array of photodiodes of an image sensor having a color filter array, wherein the photodiodes comprises first photodiodes corresponding to first filter elements of a first color, second photodiodes corresponding to second filter elements of a second color and third photodiodes corresponding to third filter elements of a third color;
determining an average response for at least a portion of first set of the first photodiodes, the first set of the first photodiodes containing those first photodiodes of a first portion of the image sensor and having a second photodiode adjacent a first side of the first photodiodes;
determining an average response for at least a portion of second set of the first photodiodes, the second set of the first photodiodes containing those first photodiodes of the first portion of the image sensor and having a third photodiode adjacent the first side of the first photodiodes;
comparing the average response for the first set of the first photodiodes to the average response for the second set of the first photodiodes, wherein a difference between the averages responses is indicative of an imbalance of a response of the first color; and
applying gain to the image data corresponding to at least one of the first set of the first photodiodes and the second set of the first photodiodes in response to the comparison.

13. The method of claim 12, wherein the color filter array is a Bayer array and the first color is green.

14. The method of claim 12, wherein determining an average response for at least a portion of a set of the first photodiodes further comprises determining the average response of only those first photodiodes of that set whose response is above some non-zero value.

15. The method of claim 14, wherein the non-zero value is a value corresponding to a response of at least about 25% of the dynamic range of the first photodiodes.

16. The method of claim 12, wherein applying gain to the image data corresponding to at least one of the first set of the first photodiodes and the second set of the first photodiodes further comprises applying gain to the set of the first photodiodes having the lower average response.

17. The method of claim 12, wherein applying gain to the image data corresponding to at least one of the first set of the first photodiodes and the second set of the first photodiodes further comprises adjusting a lens vignetting profile for the image sensor in response to the comparison of the average responses.

18. The method of claim 12, wherein comparing the average response comprises determining a ratio of one average response to the other and wherein the ratio is indicative of a degree of the imbalance.

19. The method of claim 18, wherein applying gain to the image data corresponding to at least one of the first set of the first photodiodes and the second set of the first photodiodes further comprises applying gain to the first and second sets of the first photodiodes such that a ratio of the gain applied to the image data corresponding to the first set of the first photodiodes to the gain applied to the image data corresponding to the second set of the first photodiodes is approximately equal to a ratio of the average response for the second set of the first photodiodes to the average response for the second set of the first photodiodes.

20. The method of claim 18, wherein applying gain to the image data in response to the comparison further comprises only applying the gain to the image data in response to the comparison if the ratio is within a first predetermined range of values and outside a second predetermined range of values.

21. The method of claim 12, wherein the image sensor further comprises one or more other photodiodes corresponding to filter elements of other colors.

22. The method of claim 12, further comprising:
determining an average response for at least a portion of third set of the first photodiodes, the third set of the first photodiodes containing those first photodiodes of a first portion of the image sensor and having a different pattern of adjacent photodiodes than either the first set or the second set of the first photodiodes;
comparing the average response for the first set of the first photodiodes to the average response for the third set of the first photodiodes, wherein a difference between the averages responses is further indicative of an imbalance of a response of the first color; and
applying gain to the image data corresponding to at least one of the first set of the first photodiodes, the second set of the first photodiodes and the third set of the first photodiodes in response to the comparison.

23. The method of claim 12, wherein the first portion of the image sensor corresponds to less than all photodiodes of the array of photodiodes.

24. The method of claim 12, further comprising:
repeating the method for additional portions of the image sensor.

25. An image sensor, comprising:
an array of photosensitive elements configured to collect image data indicative of a luminance intensity of two or more spectra of light;
circuitry to collect image data from the array of photosensitive elements and to compare average values of the image data for at least two different groups of photosensitive elements, each group configured to collect image data indicative of the luminance intensity of the same spectrum of light; and
circuitry to apply gain to the image data for at least one of the groups of photosensitive elements in response to the comparison.

26. The image sensor of claim 25, wherein the array of photosensitive elements are associated with a Bayer color filter array having a repeating pattern of an alternating row of green filter elements and red filter elements and an alternating row of blue filter elements and green filter elements.

27. The image sensor of claim 26, wherein the at least two different groups of photosensitive elements includes a first group of photosensitive elements corresponding to green filter elements in rows of green filter elements and red filter elements and a second group of photosensitive elements corresponding to green filter elements in rows of green filter elements and blue filter elements.

28. The image sensor of claim 27, wherein the first and second groups of photosensitive elements include only those corresponding photosensitive elements located in a first sub-array block of the array of photosensitive elements.

29. The image sensor of claim 28, wherein the array of photosensitive elements comprises more than one sub-array block.

30. The image sensor of claim 28, wherein the array of photosensitive elements comprises a grid pattern of sub-array blocks.

31. The image sensor of claim 29, wherein the sub-array blocks for use in comparing average values of image data corresponds to sub-array blocks for use in performing lens vignetting corrections for the image sensor.

32. The image sensor of claim 25, wherein the array of photosensitive elements is configured to collect image data indicative of a luminance intensity of two or more spectra of light by receiving incident light through a color filter array.

33. The image sensor of claim 32, wherein the color filter array comprises a pattern of differently colored layers of material corresponding to the desired color response or a pattern of holes of varying size corresponding to the desired color response.

34. An imager system, comprising:
an image sensor for generating image data in response to received light, the sensor comprising an array of photosensitive elements;
a color filter array overlying the image sensor, wherein the color filter array includes a pattern of filter elements, each filter element corresponding to a particular spectrum of light;
control circuitry coupled to the image sensor, wherein the control circuitry is adapted to collect image data from the array of photosensitive elements, to compare average values of the image data for at least two different groups of photosensitive elements, and to correct image data for at least one of the two different groups in response to the comparison, and wherein each of the at least two different groups of photosensitive elements for comparison is configured to collect image data indicative of luminance intensity of the same spectrum of light; and
a memory device, coupled to the control circuitry, for storing the corrected image data.

35. The imager system of claim 34, further comprising:
a display coupled to the control circuitry for displaying a representation of the received light using the corrected image data.
